(19) United States
(12) Patent Application Publication
(10) Pub. No.: US 2026/0200141 A1
(43) Pub. Date: Jul. 16, 2026

(54) MOLD PART USED FOR INJECTION MOLDING OF THERMOPLASTIC RESIN AND INJECTION MOLDING METHOD OF THERMOPLASTIC RESIN

(71) Applicant: CHEMOURS-MITSUI FLUOROPRODUCTS CO., LTD., TOKYO (JP)

(72) Inventors: AKIFUMI MATSUSHITA, SHIZUOKA (JP); TERUAKI ONDA, Shizuoka (JP); TAKAHIRO NISHIMURA, Shizuoka (JP); TAKAO NISHIO, Shizuoka (JP)

(73) Assignee: CHEMOURS-MITSUI FLUOROPRODUCTS CO., LTD., TOKYO (JP)

(21) Appl. No.: 19/565,028

(22) Filed: Mar. 12, 2026

Related U.S. Application Data
(62) Division of application No. 18/013,595, filed on Jun. 28, 2021.

(30) Foreign Application Priority Data
Jun. 29, 2020 (JP) 2020-111042

(51) Int. Cl. B29C 33/44; B29C 45/26; B29C 45/40; B29C 45/44; B29L 23/00

(52) U.S. Cl. CPC B29C 33/44; B29C 45/26; B29C 45/4435; B29C 2045/4089; B29C 2045/4492; B29L 2023/22

(57) ABSTRACT

Provided is a mold part which does not generate periodic irregularities (scale pattern) which appear in the direction orthogonal to the drawing direction (MD) of the mold part having a surface which slides parallel to a molded article when the molded article is removed from the mold after injection molding during injection molding of a thermoplastic resin (in particular, a thermoplastic fluoropolymer), an injection molding method using the same, and a molded article in which periodic irregularities (scale pattern) (which appear in the direction orthogonal to the drawing direction (MD) of the mold part) do not appear. The mold part is used for injection molding of a thermoplastic resin, and includes a surface which slides substantially parallel to a molded article when the molded article is removed from the mold after injection molding, wherein the average tilt angle in the sliding direction (MD) is 1.5° or higher.

### CROSS-REFERENCES TO RELATED APPLICATIONS

This application is divisional application of U.S. patent application Ser. No. 18/013,595 filed Dec. 29, 2022 which is a national filing under 35 U.S.C. 371 of International Application No. PCT/US2021/039296 filed Jun. 28, 2021, and claims the benefit of priority of Japanese Patent Application No. 2020-111042, filed Jun. 29, 2020, the disclosures of which are incorporated herein by reference in its entirety.

### FIELD OF INVENTION

The present invention relates to: a mold part (specifically, a core pin) suitable for injection molding of a thermoplastic resin (specifically, a thermoplastic fluoropolymer); an injection molding method; and a molded article.

### BACKGROUND TECHNOLOGY

Fluoropolymer has excellent chemical resistance, and is therefore used in chemical tubes, tube joints, etc. used in semiconductor manufacturing devices. An injection molding method is used for complex shapes such as tube joints.

On the other hand, in the manufacture of semiconductors, the inner surface of the tube joint for chemical solutions used in the semiconductor manufacturing device needs to be as clean as possible because small foreign matters (referred as particles) on a silicon substrate can lead to defective products. Therefore, there is a need for a smooth surface without any irregularities on which foreign matter (particles) remains or which become a source of foreign matter (particles).

However, in the case of those with hollow structures such as joints are molded by drawing the part of the core of the mold forming the hollow after resin injection, it has been found that periodic irregularities (scale pattern) is generated in the direction orthogonal to the drawing direction (MD) of the part (core pin) of the core of the mold.

The periodic irregularities (scale pattern) are presumed to be due to the interaction of the resin with the surface of the mold part (specifically, the core pin), and increasing mold releasability may lead to the resolution thereof. However, although a mold release agent is often applied to the mold in order to increase the mold releasability of the molded body during injection molding, the use of a mold release agent is not suitable for molding objects requiring cleanliness, because the mold release agent itself can be an impurity factor.

Specifically, in the molding of a chemical tube or tube joint for a semiconductor manufacturing device using a fluoropolymer, the fluoropolymer (specifically, PFA) has a high melting point and is molded at high temperatures. Therefore, because the release agent may volatilize and become defective or become an impurity (particles), a mold release agent cannot be used. Therefore, there is a need for a mold part and an injection molding method (as well as a molded article) which do not generate periodic irregularities (scale pattern) which appear in the direction orthogonal in the drawing direction (MD) of the mold part.

### PRIOR ART DOCUMENTS

The below-mentioned Patent Document 1 describes the use of a resin container having a surface roughness (Ra) of a core of a mold of 0.02 to 0.20 μm as a method for manufacturing a resin container (having excellent transparency) in which protein, etc. tends not to be adsorbed on the inner wall. Unfortunately, even if such a mold part having a very smooth surface is used, periodic irregularities (scale pattern) which appear in the direction orthogonal to the drawing direction (MD) of the mold part occur (Comparative Examples 1 to 3 of the present application).

On the other hand, the below-described Patent Document 2 describes a mold release method in injection molding, wherein, after a molded article (which has been injection molded by disposing an insert member for forming a through hole or recess in a cavity of a molding mold) is released from a mold by mold opening and the insert member is drawn from the molded article, the molded article is released from the mold by again inserting the insert member into the original position. Unfortunately, this method has the disadvantage of being less productive.
Patent Document 1: Japanese Unexamined Patent Application Publication No. 2016-155327
Patent Document 2: Japanese Patent Publication No. H6-94148

### SUMMARY OF THE INVENTION

### Problem to Be Resolved by the Invention

An object of the present invention is to provide a mold part which does not generate periodic irregularities (scale pattern) which appear in the direction orthogonal to the drawing direction (MD) of the mold part having a surface which slides parallel to a molded article when the molded article is removed from the mold after injection molding during injection molding of a thermoplastic resin (in particular, a thermoplastic fluoropolymer), an injection molding method using the same, and a molded article in which periodic irregularities (scale pattern) (which appear in the direction orthogonal to the drawing direction (MD) of the mold part) do not appear.

### Means for Resolving Problems

It has been found that the present invention uses a mold part which has a surface (which slides substantially parallel to a molded article when the molded article is removed from the mold after injection molding) and a specific surface state, thereby making it possible to suppress the occurrence of periodic irregularities (scale pattern) on the surface of the molded article which appear in the direction orthogonal to the drawing direction (MD) of the mold part.

That is, the present invention is as follows.
1. A mold part used for injection molding of a thermoplastic resin, wherein the mold part includes a surface which slides substantially parallel to a molded article when the molded article is removed from the mold after injection molding, and wherein the average tilt angle in the sliding direction (MD) is 1.5° or higher.
2. The mold part according to 1, which is a core pin for forming the hollow part of a molded article.
3. An injection molding method for a thermoplastic resin using the mold part according to 1 and 2.
4. The injection molding method according to 3, wherein the thermoplastic resin is a thermoplastic fluoropolymer.
5. The injection molding method according to 3 to 4, wherein the drawing speed for drawing the mold part after injection molding of the resin into a mold is 20 mm/sec or lower.
6. A molded article of a thermoplastic resin molded by injection molding using a mold part having a surface which slides parallel to a molded article when removing the molded article, wherein the average tilt angle of the mold drawing direction (MD) of the surface of the molded article is 1.5° or lower.
7. The molded article according to 6, which is a joint part for chemical solutions.

### Effect of the Invention

The present invention provides a mold part which does not generate periodic irregularities (scale pattern) which appear in the direction orthogonal to the drawing direction (MD) of the mold part without using a mold release agent, an injection molding method, and a molded article which does not have irregularities (scale pattern) (which are periodic in the direction orthogonal to the drawing direction (MD) of the mold part).

### BRIEF DESCRIPTION OF THE DRAWINGS

FIG. 1 is an explanatory view illustrating the hollow part of a molded article.

FIG. 2 is an explanatory view of the average tilt angle.

FIG. 3 is a cross sectional view of a three way joint for prototype evaluation.

FIG. 4 is a three dimensional view of the three way joint for prototype evaluation.

FIG. 5 is a photograph after the three way joint for prototype evaluation has been removed from a mold.

FIG. 6 is a cross sectional view of a core pin for prototype evaluation.

FIG. 7 is a photograph of the surface of a molded article (inner surface of a joint) obtained by injection molding at a drawing speed of 4.5 mm/sec of a mold part (core pin) of Example 1.

FIG. 8 is a photograph of the surface of a molded article (inner surface of a joint) obtained by injection molding at a drawing speed of 4.5 mm/sec of a mold part (core pin) of Comparative Example 2.

### DESCRIPTION OF THE PREFERRED EMBODIMENTS

The present invention will be described in detail hereinafter.

Injection molding is a molding method in which a resin melted by heating is poured into a mold and the temperature of the resin falls below the melting point, after which the resin is removed from the mold to obtain a molded body.

The thermoplastic resin used in injection molding of the present invention is a resin exhibiting melt flowability above the melting point, with usable examples thereof including polyethylene, polypropylene, polybutylene terephthalate, polyvinyl chloride, polystyrene, acrylonitrile/butadiene/styrene, polycarbonate, polyphthalamide, polyoxymethylene, polymethylmethacrylate, polyetheretherketone, polyamideimide, polyetherimide, polyphenylene sulfide, thermoplastic fluoropolymer, etc.

Although the abovementioned various types of thermoplastic resins can be used for injection molding using the mold part according to the present invention, a molded article having a smooth surface can be obtained without using a mold release agent, making it particularly useful for molding chemical piping or joints used in semiconductor manufacturing using a thermoplastic fluoropolymer.

The thermoplastic fluoropolymer is a fluoropolymer exhibiting melt flowability above its melting point, with examples thereof including melt flowable polytetrafluoroethylenes (PTFEs), tetrafluoroethylene/perfluoro (alkyl vinyl ether) copolymers (PFAs), tetrafluoroethylene hexafluoropropylene copolymers (FEPs), tetrafluoroethylene hexafluoropropylene perfluoro (alkyl vinyl ether) copolymers, tetrafluoroethylene ethylene copolymers, polyvinylidene fluorides, polychlorotrifluoroethylenes, chlorotrifluoroethylene ethylene copolymers, etc.

Among thermoplastic fluoropolymers, specifically, thermoplastic perfluoropolymers such as a low molecular weight PTFE, PFA, FEP, or tetrafluoroethylene/hexafluoropropylene/perfluoro (alkyl vinyl ether) copolymers are specifically preferably used due to their excellent chemical resistance in the application of chemical piping or joints, etc. Among these, PFAs have excellent heat resistance and are most preferable. The perfluoro (alkyl vinyl ether) (PAVE), which is a comonomer contained in PFAS, preferably has an alkyl group having one to five carbon atoms, with preferably used examples thereof including a perfluoroethyl vinyl ether (PEVE) having two carbon atoms and perfluoropropyl vinyl ether (PPVE) having three carbon atoms.

When PFAs are used, in order to fill the resin into the mold during injection molding without defects, a PFA having high flowability in the molten state or a PFA having a melt flow rate (MFR) of 10 g/10 minutes or more is preferably used.

Moreover, the mold releasability from a mold is presumably improved when the terminal of the molecular chain of the PFA is a —CF₃ group and the other unstable terminal groups are 10 or less per 106 carbon atoms.

The terminal of the polymer chain can be a —CF₃ group by treatment with fluorine gas, with this treatment capable of being carried out via the method described in JP 62-104822 A, etc.

The mold part used in injection molding of the present invention is a mold part having a surface which slides substantially parallel when removing the molded article after injection molding. Examples thereof include an injection molding mold which has a mold part (core pin) for forming a hollow part or a constituent surface substantially parallel to the mold drawing direction after resin filling.

In the present invention, the surface which slides substantially in parallel is a surface within 5° from parallel to the direction in which the molded article is removed from the mold or the direction in which the mold is drawn from the molded article (when the molded article is removed from the mold).

The hollow part is a structure which is formed using one or more core pins, wherein the shape is not limited as long as the core pins can be drawn once the resin has solidified.

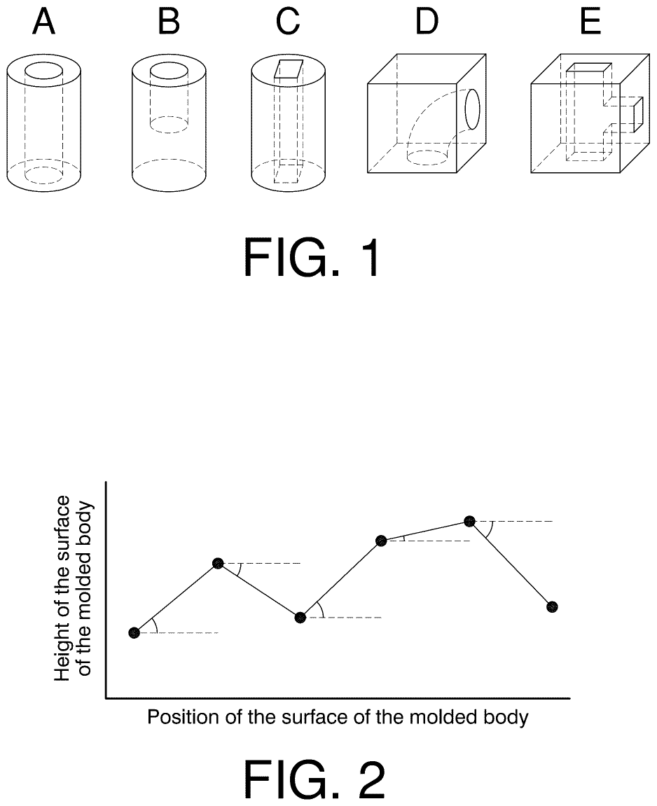

The hollow part may penetrate through the molded body as in A of FIG. 1 but need not penetrate therethrough as in B thereof. Moreover, the hollow part may be circular or may have a quadrangular or other shape as in C. The hollow part may be curved as in D, with the hollow parts capable of intersecting each other as in E.

The average tilt angle of the sliding direction (MD, the drawing direction) of the mold part used in the injection molding of the present invention is 1.5° or higher. The average tilt angle is more preferably 2.0° or higher.

The upper limit is not set, but is preferably 5.0° or lower, more preferably 4.5° or lower, and further preferably 4.0° or lower.

The average tilt angle is the value obtained by analyzing the cross sectional profile of the mold part or the molded body obtained using a measurement device such as a coherence scanning interferometer. In the present invention, the cross sectional profile is a profile obtained by taking the height of the surface of the mold part or the molded body on the vertical axis, provided that the position of the surface of the mold part or the molded body in the sliding direction of the molded body and the mold part as the horizontal axis. The average tilt angle is the average angle obtained by averaging each angle (within the observation range) at which the straight line (obtained by connecting two consecutive observation points (which form a cross sectional profile as in FIG. 2)) intersects the straight line (parallel to the sliding surface). In the measurement of the average tilt angle of the present invention, an apparatus is required in which the resolution in the height direction (vertical axis) is 5 nm or more, while the resolution in the width direction (horizontal axis) is 1 μm or more. As measurement conditions, the measurement length is 100 μm, the sampling interval is 0.54 μm, and the interval between the cross sectional profiles is 50 μm in the direction perpendicular to the sliding direction, such that the average tilt angle of the present invention is obtained by averaging ten measurements.

When the average tilt angle is small, periodic irregularities (scale pattern) which appear in the direction orthogonal to the drawing direction (MD) of the mold part tend to be generated.

In contrast, if the average tilt angle is too large, large irregularities are transferred to the molded article, problematically making it difficult to obtain a smooth surface.

In the injection molding method according to the present invention, the speed at which the mold part is drawn from the molded article to remove the molded article from the mold after the resin is injected into the mold is preferably 20 mm/sec or less.

It is more preferably 10 mm/sec or lower, further preferably 5 mm/sec or lower, and most preferably 3 mm/sec or lower.

This is because, when the drawing speed is high (fast), periodic irregularities (scale pattern) which appear in the direction orthogonal to the drawing direction (MD) of the mold part tend to be generated. The surface of the resin undergoes shear stress upon drawing the mold part. However, if the drawing speed is high, the shear stress increases and greatly deforms the resin, consequently presumably tending to generate periodic irregularities (scale pattern).

The material of the mold part used in injection molding of the present invention can be a metal used in a mold for injection molding of typical resins, with examples thereof including stainless steel, prehardened steel, carbon steel, high speed steel, nickel chrome steel, nickel chromium molybdenum steel, etc. Among these, nickel chromium molybdenum steel is preferably used. The reasons for this are as follows. Because the fluoropolymer generates corrosive gas in the molten state, chromium or nickel is often plated on the mold in order to prevent corrosion. However, repetitive molding may peel off plating, allow corroded metal to enter a molded body, and cause defective products. In contrast, nickel chromium molybdenum steel is highly corrosive but does not require plating, preventing the abovementioned problems from occurring.

The molded article according to the present invention has a smooth surface without periodic irregularities (scale pattern) which appear in the direction orthogonal to the drawing direction (MD) of the mold part. While the presence of periodic irregularities (scale pattern) can be observed by microscope surface observation, they can also be evaluated by measuring the average tilt angle of the mold part in the drawing direction (MD).

The average tilt angle increases when there are periodic irregularities (scale pattern), such that the average tilt angle of the surface of the molded article according to the present invention in the mold drawing direction (MD) is 1.5° or lower. It is smoother and preferable when it is 1.0° or lower. It is more preferably 0.5° or lower.

Further, there is no need to use a mold release agent. In this case, foreign matter derived from the mold release agent also advantageously does not remain on the surface. As a result, the molded article according to the present invention is suitable as a joint part for chemical solutions for a semiconductor manufacturing device of a thermoplastic fluoropolymer (particularly, PFA).

### EXAMPLES

The present invention will be described below in further detail by presenting examples and comparative examples; however, the present invention is not limited to these examples.

### Injection Molding

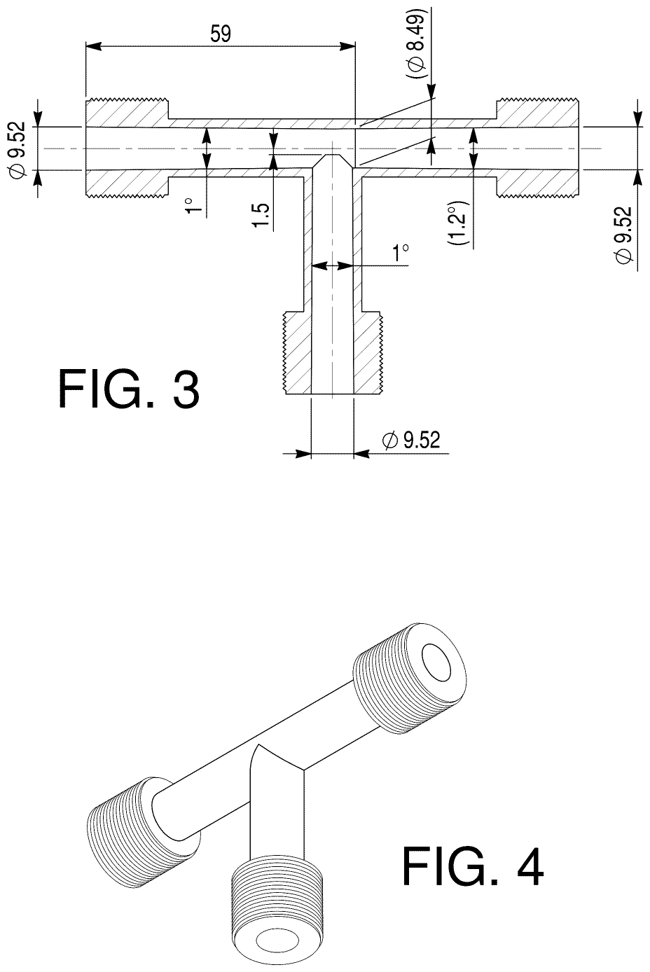

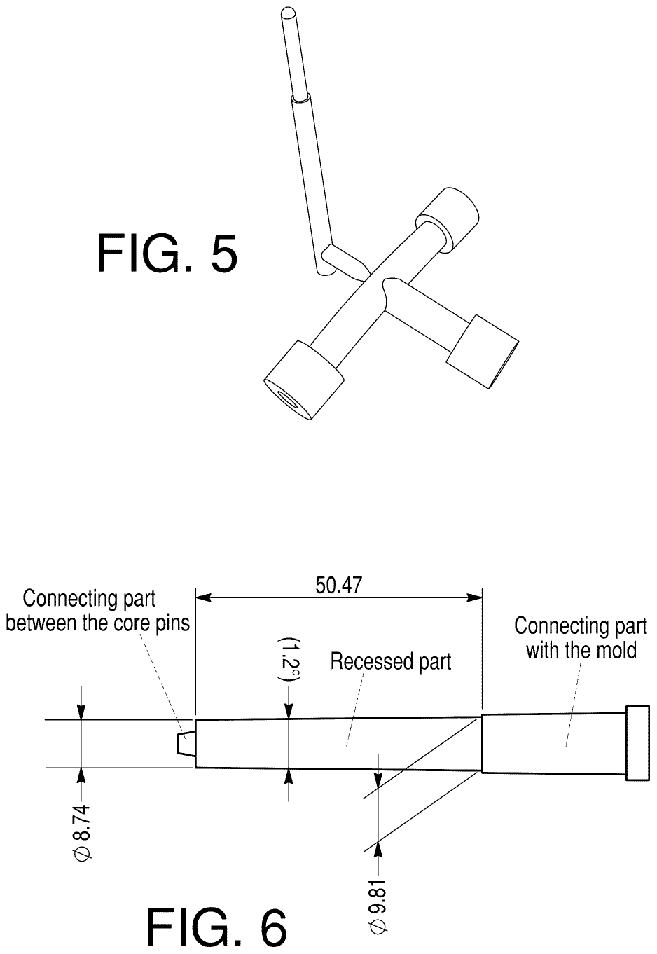

Using a NEX180-36E injection molding machine, a PFA (Teflon (registered trademark) (manufactured by Chemours-Mitsui Fluoroproducts Co., Ltd.) PFA 440HP-J [tetrafluoroethylene/perfluoroethyl vinyl ether copolymer, MFR15 g/10 min, melting point of 308° C., unstable terminal groups (—CH2OH terminal group, —CONH2 terminal group, and —COF terminal group) are six or less per 106 carbon atoms]) was injected (and the pressure maintained) for 30 seconds at a resin temperature of 380° C., a mold temperature of 160° C., an injection pressure and holding pressure of 50 MPa, and an injection speed of 6 mm/sec, then cooled for 10 seconds, and then the mold was opened. After 30 seconds, the molded body was removed from the mold, allowing the three way joints illustrated in FIGS. 3 to 5 to be molded. Three core pins were used to mold the hollow part, wherein the core pins were designed to simultaneously release as the mold is opened. The drawing speed of the core pin was at three levels of 15 mm/sec, 4.5 mm/sec, and 1.5 mm/sec.

With regard to the shape of the core pin, the part of the base at the contact part with the resin was circular with a diameter of approximately 9.8 mm, and the length of the recessed part was 50.47 to 60.77 mm (slightly different depending on the direction of each joint of the three way joints (horizontal left and right direction, and down direction), becoming thinner from the base to the tip, with a slope thereof of approximately 1.1° (1.0 to) 1.2°, while the diameter of the tip part was approximately 8.8 mm. A dimensional view of the cross section of the core pin recessed in the horizontal direction is illustrated in FIG. 6. The core pin has six levels, but all of the outer dimensions are identical. A high speed steel SKH51 (in accordance with JIS G4403) or nickel chromium molybdenum steel (MA276 manufactured by Hitachi Metals, Ltd.), which was subjected to chrome plating, was used as the material.

### Melt Flow Rate of the PFA

Using a corrosive-resistant melt indexer (manufactured by Toyo Seiki Seisaku-sho, Ltd.) equipped with a cylinder, orifice, along with a piston in accordance with ASTM D 1238-95, 5 g of the sample was filled into the cylinder maintained at 372±1° C. for five minutes, then extruded through an orifice under a 5 kg load (piston and weight), after which the amount of the melt extruded at this time per 10 minutes (g/10 min) was determined as the MFR.

### Unstable Terminal Group of the PFA

The unstable terminal group of the PFA was measured via the methods described in U.S. Pat. Nos. 3,085,083 and 4,675,380.

### Measurement of the Surface State

The method for measuring the surface state (average tilt angle, surface roughness Ra) of the mold part and molded article according to the present invention will be illustrated below.

The measurement mode was set to wave using a 10-fold interference objective using a scanning coherence scanning interferometer manufactured by Hitachi High-Tech Science Corporation so as to scan the sample surface. From the scanned three dimensional image, 10 (N=10) cross sectional profiles in the sliding direction (MD) was acquired at intervals of 50 μm in the direction vertical to the sliding direction (MD), after which the arithmetic average roughness (Ra) [μm] and the average tilt angle [°] of each of the cross sectional profiles obtained were averaged to obtain a measurement value.

Moreover, the presence of periodic irregularities (scale pattern) was visually determined from microscope image observation.

### Example 1

A surface polished core pin with MA276 serving as a material was subjected to blasting. The arithmetic average roughness (Ra) in the sliding direction (MD) was 0.202 μm, while the average tilt angle was 2.546°.

The surface was measured on the core pin sliding surface (inner surface of the joint) of a molded article (three way joint) obtained by injection molding via the abovementioned method using this core pin. The results are shown in Table 1.

### Example 2

A surface polished core pin with MA276 serving as a material was subjected to blasting. The arithmetic average roughness (Ra) in the sliding direction (MD) was 0.263 μm, while the average tilt angle was 4.043°.

The surface was measured on the core pin sliding surface (inner surface of a joint) of the molded article (three way joint) obtained by injection molding via the abovementioned method using this core pin. The results are shown in Table 1.

### Example 3

A surface polished core pin was used after chrome plating on the high speed steel SKH51. The arithmetic average roughness (Ra) in the sliding direction (MD) was 0.123 μm, while the average tilt angle was 1.737°.

The surface was measured on the core pin sliding surface (inner surface of a joint) of the molded article (three way joint) obtained by injection molding via the abovementioned method using this core pin. The results are shown in Table 1.

### Comparative Example 1

The surface polished core pin was subjected to mirror surface treatment using fine blasting after chrome plating the high speed steel SKH51. The arithmetic average roughness (Ra) in the sliding direction (MD) was 0.048 μm, while the average tilt angle was 1.089°.

The surface was measured on the core pin sliding surface (inner surface of a joint) of the molded article (three way joint) obtained by injection molding via the abovementioned method using this core pin. The results are shown in Table 1.

### Comparative Example 2

A surface polished core pin was used after chrome plating the high speed steel SKH51. The surface was finely polished so that the surface was smoother than Example 3. The arithmetic average roughness (Ra) in the sliding direction (MD) was 0.059 μm, while the average tilt angle was 0.762°.

The surface was measured on the core pin sliding surface (inner surface of a joint) of the molded article (three way joint) obtained by injection molding via the abovementioned method using this core pin. The results are shown in Table 1.

### Comparative Example 3

The surface polished core pin was subjected to mirror surface treatment using fine blasting after chrome plating the high speed steel SKH51. Finer blasting than Comparative Example 1 was carried out. The arithmetic average roughness (Ra) in the sliding direction (MD) was 0.030 μm, while the average tilt angle was 0.131°.

The surface was measured on the core pin sliding surface (inner surface of a joint) of the molded article (three way joint) obtained by injection molding via the abovementioned method using this core pin. The results are shown in Table 1.

When the core pin drawing speed was 15 mm/sec, the molded article was pulled apart upon being removed from the mold and the molded article was not obtained.

TABLE 1

| | | | Surface of the PTA forming body (inner surface of the | | | |
|---|---|---|---|---|---|---|
| | | | three way joint) | | | |
| | Core pin | | Drawing speed of 15 mm/sec | | | |
| | | Average | | Average | | |
| | Ra | tilt | Ra | tilt | Scale | |
| | (MD) | angle | (MD) | angle | pattern | |
| | [μm] | [°] | [μm] | [°] | Presence | |
| Example 2 | 0.263 | 4.043 | 0.146 | 1.117 | None | |
| Example 1 | 0.202 | 2.546 | 0.074 | 0.745 | None | |
| Example 3 | 0.123 | 1.737 | 0.051 | 0.596 | None | |
| Comparative | 0.048 | 1.089 | 0.167 | 2.021 | Present | |
| Example 1 | | | | | | |
| Comparative | 0.059 | 0.762 | 0.142 | 2.370 | Present | |
| Example 2 | | | | | | |
| Comparative | 0.030 | 0.131 | Damage upon removing the molded article | | | |
| Example 3 | | | | | | |
| | Drawing speed of 4.5 mm/sec | | | Drawing speed of 1.5 mm/sec | | |
| | | Average | | | Average | |
| | Ra | tilt | Scale | Ra | tilt | Scale |
| | (MD) | angle | pattern | (MD) | angle | pattern |
| | [μm] | [°] | Presence | [μm] | [°] | Presence |
| Example 2 | — | — | — | 0.160 | 1.032 | None |
| Example 1 | 0.085 | 0.550 | None | 0.065 | 0.472 | None |
| Example 3 | — | — | — | 0.139 | 0.483 | None |
| Comparative | | | — | 0.100 | 1.541 | Present |
| Example 1 | | | | | | |
| Comparative | 0.126 | 2.662 | Present | 0.094 | 2.497 | Present |
| Example 2 | | | | | | |
| Comparative | — | — | — | 0.156 | 2.993 | Present |
| Example 3 | | | | | | |

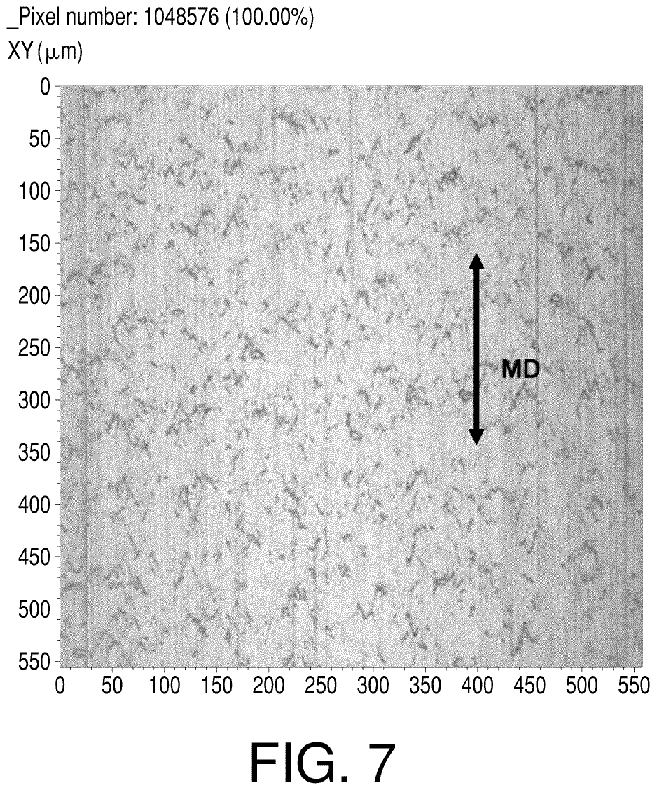

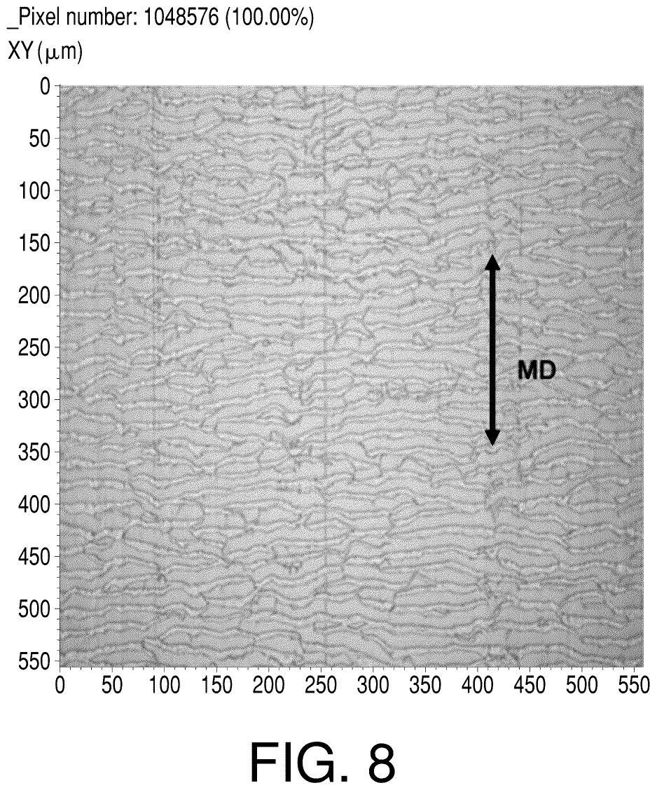

As an example of the determination of the presence of periodic irregularities (scale pattern) using microscope imaging (photograph), FIG. 7 illustrates an image of the surface of a molded article (inner surface of a joint) obtained by injection molding at a drawing speed of an inventive mold part (core pin) of 4.5 mm/sec, while FIG. 8 illustrates an image of the surface of a molded article (inner surface of a joint) obtained by injection molding at a drawing speed of a molding part (core pin) of 4.5 mm/sec of Comparative Example 2.

It was found that while periodic irregularities are observed in FIG. 8, FIG. 7 has some portions resembling irregularities but no periodic irregularities (scale pattern).

### INDUSTRIAL APPLICABILITY

The present invention provides a mold part which does not generate periodic irregularities (scale pattern) which appear in the direction orthogonal to the drawing direction (MD) of the mold part having a surface which slides parallel to a molded article when the molded article is removed from the mold after injection molding during injection molding of a thermoplastic resin, an injection molding method using the same, and a molded article in which periodic irregularities (scale pattern) (which appear in the direction orthogonal to the drawing direction (MD) of the mold part) do not appear. In particular, a molded article having a smooth surface can be obtained without using a mold release agent, making it particularly useful for molding chemical piping or joints used in semiconductor manufacturing using a thermoplastic fluoropolymer.

What is claimed is:

1. A mold part used for injection molding of a thermoplastic fluoropolymer, wherein: the mold part includes a surface which slides substantially parallel to a molded article when the molded article is removed from the mold after injection molding; and the average tilt angle in the sliding drawing direction (MD) is 1.5° or higher.

2. The mold part according to claim 1, wherein the mold part is a core pin for forming a hollow part of the molded article.

3. An injection molding method for a thermoplastic resin using the mold part according to claim 1.

4. The injection molding method according to claim 3, wherein the drawing speed for drawing the mold part after injection molding of the resin into a mold is 20 mm/sec or lower.
